(19) United States
(12) Patent Application Publication
(10) Pub. No.: US 2010/0007655 A1
(43) Pub. Date: Jan. 14, 2010

(54) ENERGY USAGE DISPLAY DEVICE

(75) Inventors: Michael AGRONIN, Owings Mills, MD (US); Gerry O'BRIEN, Ottawa (CA)

Correspondence Address: THE BLACK & DECKER CORPORATION, 701 EAST JOPPA ROAD, TW199, TOWSON, MD, 21286, US

(73) Assignee: BLACK & DECKER INC., Newark, DE (US)

(21) Appl. No.: 12/480,418

(22) Filed: Jun. 8, 2009

Related U.S. Application Data
(60) Provisional application No. 61/059,508, filed on Jun. 6, 2008.

(51) Int. Cl. G09G 5/00; G06F 17/00

(52) U.S. Cl. 345/214; 705/412

(57) ABSTRACT

A home energy display that receives energy consumption data from a sensor or other source mounted to a home's electric meter. The display can accommodate various pricing structures including tiered rates and time-of use rates and shows various energy consumption information, including real time energy consumption and its associated cost. The display can also “zero out” a home's energy use to provide a base line so that any additional use (e.g. by a single or group of appliances) can be calculated.

### CROSS-REFERENCE TO RELATED APPLICATION

This application claims priority to Provisional Application 61/059,508 filed Jun. 6, 2008. The entire contents of that application are expressly incorporated herein by reference.

### FIELD OF THE INVENTION

The present invention relates to a home energy monitor display that receives information from an energy monitoring sensor, and displays various energy usage information to a user.

### BACKGROUND OF THE INVENTION

Home energy monitoring and display devices are known in the art and give users information about their energy use so they can better control their costs. Examples of such devices are disclosed in U.S. Pat. Nos. 7,174,260; 7,317,404; 7,043,380; and British Patent GB 295,879. These patents disclose display units that show various household energy usage information. Although these displays give users broad information about total energy use, they are unable to provide information on the energy usage of a single home appliance.

### BRIEF SUMMARY OF THE INVENTION

The present invention discloses a home energy display that receives energy consumption data from a sensor or other source. The display shows energy usage information and is able to perform calculations that convert the energy usage into dollars so that the user can see how much his energy consumption is costing. It also includes a tare feature that can “zero out” a home's energy use to provide a base line so that any additional use (e.g. by a single or group of appliances) can be calculated.

### BRIEF DESCRIPTION OF THE INVENTION

Further features and advantages of the present invention will be better understood by reference to the following description, which is given by way of example and in association with the accompanying drawings, in which:

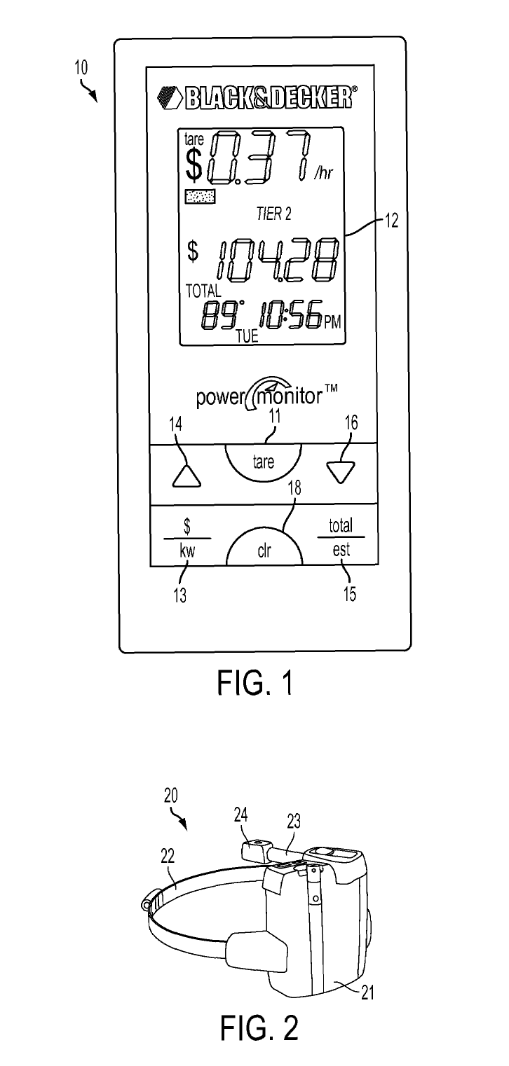

FIG. 1 is a front view of the display of the present invention;

FIG. 2 shows a sensor of the present invention;

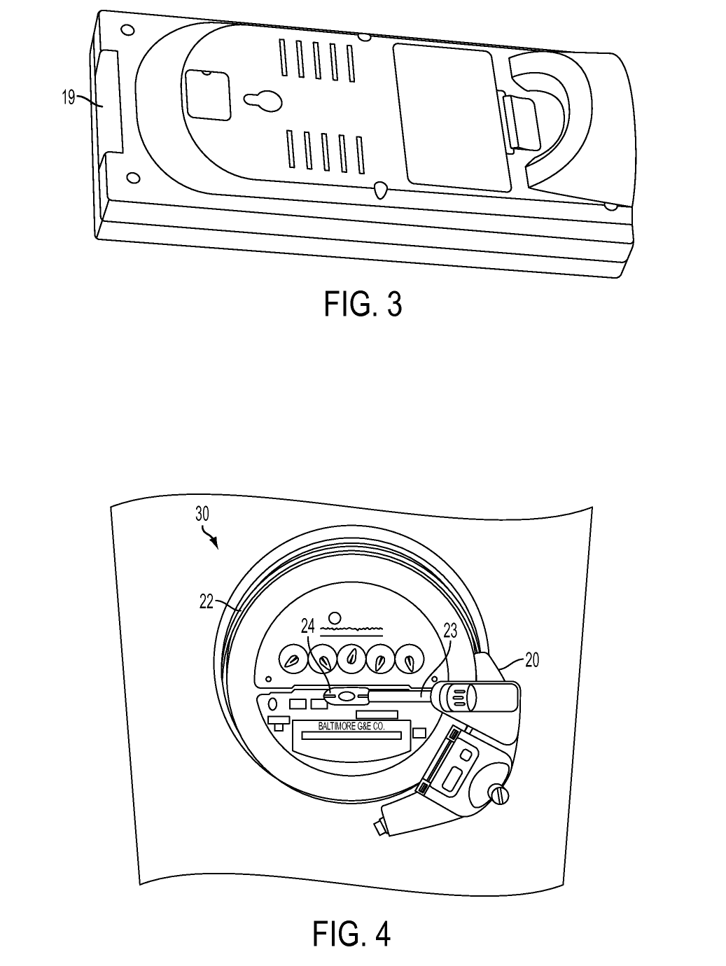

FIG. 3 is a rear view of the display of FIG. 1;

FIG. 4 shows the sensor of FIG. 2 attached to an electric meter;

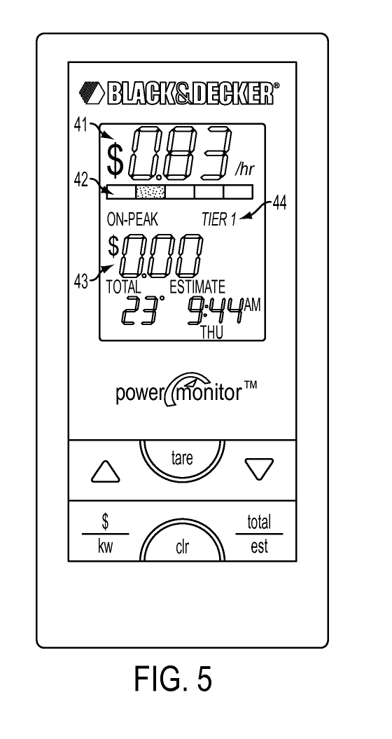

FIG. 5 shows the display in a cost mode; and

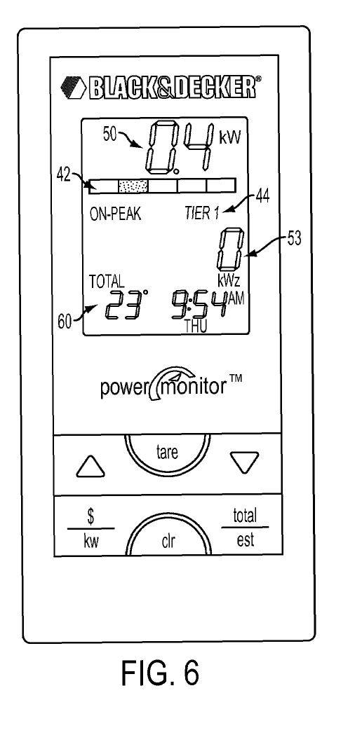

FIG. 6 shows the display in a power mode.

### DETAILED DESCRIPTION OF THE INVENTION

FIG. 1 shows the display 10 of the present invention. The display includes a digital viewing area 12, increase and decrease buttons 14, 16, a clear button 18, a tare button 11, a cost/power button 13, a consumption button 15, and a program button 10 (see FIG. 3). The display 10 is used with a sensor 20, such as one described in U.S. Pat. No. 7,174,260, which is incorporated herein by reference.

The sensor 20, shown in FIG. 2, is attached to a home electrical meter 30 using an adjustable strap 22. The sensor has a main housing 21 for holding batteries. An adjustable arm 23 extends from the housing 21 and holds a sensor head 24 over the output of the electrical meter. The sensor 20 wirelessly transmits information to the display 10 to provide the user with real-time information on the home's energy consumption.

The display 10 receives the energy usage information from the sensor and is able to display this information is various ways. The display is able to show the total energy usage of the home in real time, is able to calculate the accumulated energy usage over a period of time, estimate a monthly usage, and show the energy usage of a single device. The display can also take this energy information and convert it into dollars to show the user the cost of his energy consumption.

To use the display, it must first be programmed with billing information (from the energy company) to properly show the cost information. The billing information is entered by pressing the program button 19, which initiates a series of data entries. The user enters information using the decrease and increase buttons 14 and 16 to select the desired number or answer. Initially, the display prompts the user to enter the time and date, which the user can do by pressing the decrease and increase buttons 14 and 16.

The display then prompts the user to enter his energy company's billing information, including whether there is a flat rate, tiered rate, or time-of-use rate. If the user has a flat rate, he selects this option and then enters the billing rate using the increase and decrease buttons 14 and 16.

If the user has a tiered rate, he selects this option and the display prompts the user to enter the billing rate for each tier. A tiered rate is used when electric companies set a first price for a predetermined amount of energy, and a second price for when energy over the predetermined amount is used. The display prompts the user to enter the billing rate for the first tier and its threshold limit, and the billing rate for the second tier. In this way, the display knows that the second billing rate should be used when calculating the associated cost information when the threshold is crossed. After information for the second tier is entered, the display asks whether there is an additional tier, and any additional tier information can be entered. When all the information is entered, the user presses the increase or decrease button to indicate there are no more tiers.

If the user has a time-of-use rate, he selects this option and the display asks the user whether this type of billing applies on weekends, and then prompts him to enter the peak and off-peak billing rates and their respective time windows.

Once all this information is entered, the display is able to show the user a variety of information, including his current electricity usage, the usage of a single appliance, the accumulated usage over an hour, a day or any extended period of time, and an estimated monthly usage. The user can press the cost/power button 13 to toggle between cost and power views in the display, with the cost view shown in FIG. 5 and the power view shown in FIG. 6.

In the cost view of FIG. 5, the viewing area 12 is divided into several sections to show various information. The display 10 can show the cost per hour of electricity usage 40, includes a usage bar 42 to indicate whether consumption is increasing or decreasing, shows the total accumulated cost 43 since hitting the clear button 18, and for tiered or time-of-use billing shows the tier or time slot 44.

In the power view of FIG. 6, the power being currently being consumed (typically in kilowatts) 50 is shown, and the total accumulated power consumed 53 since hitting the clear button. Additionally, in both views, the time and temperature 60 are shown at the bottom of the viewing area 12.

The display also allows the user to check the energy consumption of a single appliance. To do this, the user presses the tare button 11, which “zeros out” the current energy consumption. The user can then turn on any additional appliances, and the energy consumption of those appliance will be shown on the display. The user can press the tare button again to exit out of this mode and return to the displays normal operation.

Although a preferred embodiment has been disclosed, it should be noted that the description of the invention is merely exemplary in nature and, thus, variations that do not depart from the gist of the invention are intended to be within the scope of the invention. Such variations are not to be regarded as a departure from the spirit and scope of the invention.

1. An energy consumption display comprising:
a sensor attached to an electrical meter;
a display capable of receiving energy information from the sensor and having a viewing screen to show the energy information, and a first and second button to enter data; and
a tare button that allows the display to zero-out the energy consumption so that the energy use of a subsequently turned on appliance is displayed.

2. The energy consumption display of claim 1, wherein the display receives the energy information wirelessly.

3. The energy consumption display of claim 1, wherein the display is powered by batteries.

4. The energy consumption display of claim 1, wherein the energy information can be viewed in at least two formats.

5. The energy consumption display of claim 4, wherein a first format show the energy information in kilowatts and a second format shows the energy information in dollars.

6. The energy consumption display of claim 5, wherein the display is programmed to prompt a user with questions related to his energy costs, and the user enters the energy cost information using the first and second buttons.

7. An energy consumption display comprising:
a housing having a front surface and a back surface, the front surface having a screen on an upper portion thereof, the back surface having a leg for supporting the housing in an upright position;
a receiver in the housing capable of receiving wireless signals containing energy usage information, the display showing the energy information on the screen;
a tare button on the housing that allows the display to zero-out the energy usage so that the energy use of a subsequently turned on appliance is displayed.

8. The energy consumption display of claim 7, wherein the display is powered by batteries

9. The energy consumption display of claim 7, wherein the energy information can be displayed in at least two formats.

10. The energy consumption display of claim 9, wherein a first format show the energy information in kilowatts and a second format shows the energy information in dollars.

11. The energy consumption display of claim 10, wherein the display is programmed to prompt a user with questions related to his energy costs, and the user enters the energy cost information using a first and a second button.
